(19) United States
(12) Patent Application Publication
(10) Pub. No.: US 2024/0185323 A1
(43) Pub. Date: Jun. 6, 2024

(54) RETAIL ASSISTANCE SYSTEM FOR ASSISTING CUSTOMERS

(71) Applicant: RN CHIDAKASHI TECHNOLOGIES PRIVATE LIMITED, Mumbai (IN)

(72) Inventors: Prashant Iyengar, Mumbai (IN); Hardik Godara, Jodhpur (IN)

(21) Appl. No.: 18/282,532

(22) PCT Filed: Mar. 23, 2022
(86) PCT No.: PCT/IN2022/050288

§ 371 Date: Sep. 17, 2023

(51) Int. Cl. G06Q 30/0601; G06Q 30/015

(52) U.S. Cl. CPC G06Q 30/0631; G06Q 30/015

(57) ABSTRACT

A system and method for retail assistance system (102) for assisting customers while shopping in a retail store. The retail assistance system (102) is configured to detect one or more customers entering the retail store using an input unit, determine a personality profile of the one or more customers by analyzing a facial expression and one or more personal attributes of the one or more customers, determine one or more personalized recommendations for the one or more customers by analyzing the personality profile, past purchase history of the one or more customers, and visit history of the one or more customers in the retail store using a machine learning model, and enable the at least one of customer to choose the one or more personalized recommendations.

### BACKGROUND

### Technical Field

The embodiments herein generally relate to customer experience management, more particularly to a system and method for retail assistance to customers using an artificially intelligent machine.

### Description of the Related Art

In recent times, customer satisfaction has acquired importance as the choices for the customers have increased many times when it comes to retail consumerism. It has been increasingly important for the retail stores to assist the customers in a way that is both non-obstructive and efficient to fulfill the customer's needs. Generally, there have been difficulties for the customers navigating a huge store and finding what they are looking for. Also, visiting stores has been time-consuming and cumbersome if the right kind of assistance is not provided. There has been a system of assisting customers by store personnel traditionally. But it is not possible for store personals to give personised attention to the customers or to recommend a product or a service in a non-obstructive way. Also, the store personnel have physical and mental limitations to assist each and every customer, especially during busy times. Knowing the customer is very important to have an effective interaction and thereby maximize customer satisfaction. But mostly during busy times, it's hard to find proper assistance for the customers. Also, customers may not give a review of their store visit each time. Thereby, the stores may not have data for improvement of customer service. There have been some robot assistance systems in the market to overcome the aforementioned problems but they are very limited in providing a personalized experience to the customer.

Accordingly, there is a need for a more precise system and method for retail assistance provided to the customers to avoid the aforementioned complications.

### SUMMARY

In view of the foregoing, an embodiment herein provides a retail assistance system for assisting customers while shopping in a retail store. The retail assistance system includes a memory and a processor. The memory includes one or more instructions. The processor executes the one or more instructions. The processor is configured to detect, using an input unit, at least one customer entering the retail store. The processor is configured to determine whether at least one customer is a new visitor or an old visitor by detecting a face of at least one customer. The processor is configured to detect, using a machine learning model, an emotional state of at least one customer by analyzing facial expression of at least one customer. The processor is configured to determine, using the machine learning model, a personality profile of at least one customer by analyzing the facial expression and one or more personal attributes of at least one customer. The one or more personal attributes includes at least one of age, gender, or ethnicity of at least one customer. The processor is configured to determine, using the machine learning model, one or more personalized recommendations for at least one customer by analyzing the personality profile, past purchase history of at least one customer, and visit history of at least one customer in the retail store. The processor is configured to enable the at least one of customer to choose the one or more personalized recommendations.

In some embodiments, the processor is configured to determine, using the machine learning model, the one or more personalized recommendations for at least one customer by tracking in-store purchases of at least one customer in real-time. The processor is configured to enable at least one customer to choose the one or more personalized recommendations.

In some embodiments, the retail assistance system includes a knowledge database that stores the one or more personal attributes of at least one customer if at least one customer is the new visitor, the past purchase history of at least one customer, and the visit history of at least one customer.

In some embodiments, the input unit includes any of a camera, a microphone, or one or more sensors to detect at least one customer entering the retail store.

In some embodiments, the retail assistance system includes a face recognition system that detects, analyzes, and verifies a face of at least one customer, to determine at least one customer is the new visitor or the old visitor. The faces of new visitors are stored in the knowledge database. The processor is configured to detect the face of the at least one customer by comparing one or more faces of the customer stored in the knowledge database.

In some embodiments, the retail assistance system includes a tracking system that track at least one customer throughout the retail store to provide the one or more recommendations to at least one customer.

In some embodiments, the one or more sensors include any of an array of cameras or audio acquisition systems.

In some embodiments, the processor is configured to interact at least one of a welcome message or a goodbye message by determining whether the at least one customer is entering or exiting the retail store.

In an aspect, a method of assisting customers while shopping in a retail store is provided. The method includes detecting at least one customer entering the retail store using an input unit. The method includes determining whether at least one customer is a new visitor or an old visitor by detecting a face of at least one customer in a knowledge database. The method includes detecting an emotional state of at least one customer by analyzing facial expression of at least one customer using a machine learning model. The method includes determining a personality profile of at least one customer by analyzing the facial expression and one or more personal attributes of at least one customer using the machine learning model. The one or more personal attributes include at least one of age, gender, or ethnicity of at least one customer. The method includes determining one or more personalized recommendations for at least one by analyzing the personality profile, past purchase history of at least one customer, and visit history of at least one customer in the retail store using the machine learning model. The method includes enabling at least one customer to choose the one or more personalized recommendations.

In some embodiments, the method includes determining the one or more personalized recommendations for at least one customer by tracking in-store purchases of at least one customer in real-time using the machine learning model. The method includes enabling at least one customer to choose the one or more personalized recommendations.

The retail assistance system provides better customer satisfaction, smooth in-store experience, and increased sales at the retail store. The retail assistance system provides one or more recommendations to the customer based on personality profile, past purchase, visit history, and the like to improve overall shopping experience of at least one customer. The retail assistance system reduces time spent trying to find the desired items for at least one customer, improves customer experience, and customizes the responses such that the customers have a personalized experience with improved efficacy, and also achieves profits by focused sales targets and intelligent product selection and placement achieved by analyzing the data gathered through the customer interactions and purchase and browsing history. The product promotions to the right set of customers improve the chances of the purchase being made many folds. The customer may buy more things at the retail store and be satisfied with the service and efficiency without any waste of men's hours.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a retail assistance system for assisting customers while shopping in a retail store according to some embodiments herein;

FIG. 2A illustrates a block diagram of the retail assistance system according to some embodiments herein;

FIG. 2B illustrates a block diagram of a person occupancy counter module according to some embodiments herein;

FIG. 2C illustrates a block diagram of a person attribute detection module according to some embodiments herein;

FIG. 3A illustrates an exemplary block diagram of the person attribute detection module for detecting ethnicity according to some embodiments herein;

FIG. 3B illustrates an exemplary block diagram of the person attribute detection module for detecting a gender according to some embodiments herein;

FIG. 3C illustrates an exemplary block diagram of the person attribute detection module for detecting age according to some embodiments herein;

FIG. 4 illustrates a block diagram of an emotional recognition module according to some embodiments herein;

FIG. 5 illustrates a flow diagram of the retail assistance system to initiate a conversation according to some embodiments herein;

FIG. 6 illustrates a flow diagram of a method of capturing retail store visit data according to some embodiments herein;

FIG. 7 illustrates an exemplary graphical representation of placements of one or more sensors at the retail store according to some embodiments herein;

FIG. 8 illustrates an exemplary graphical representation of tracking of at least one of customer at the retail store according to some embodiments herein;

FIG. 9 illustrates an exemplary flow chart of generating an output at the AI machine assistant according to some embodiments herein;

FIG. 10 illustrates an exemplary flow chart of a method of generating an output on the retail assistance system based on modes of conversation of at least one of customer according to some embodiments herein;

FIG. 11 is a flow diagram of a method of assisting customers while shopping in a retail store according to some embodiments herein; and

FIG. 12 is a schematic diagram of a computer architecture of the retail assistance system in accordance with the embodiments herein.

### DETAILED DESCRIPTION OF PREFERRED EMBODIMENTS

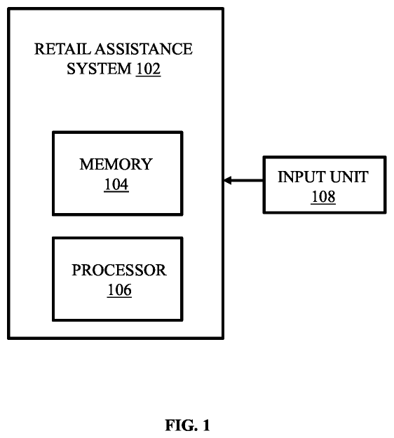

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Referring now to the drawings, and more particularly to FIGS. 1 through 12, where similar reference characters denote corresponding features consistently throughout the figures, preferred embodiments are shown.

FIG. 1 illustrates a system view of a retail assistance system 102 for assisting customers while shopping in a retail store according to some embodiments herein. The system view includes the retail assistance system 102, and an input unit 108. The input unit 108 is configured to provide one or more inputs to the retail assistance system 102. The input unit 108 may include one or more sensors, an array of cameras, or audio acquisition systems that can be placed across the retail store. The input unit 108 may work along with a combination of fixed and mobile fixtures which are connected to the retail assistance system 102.

The retail assistance system 102 includes a memory 104 and a processor 106 to assist customers while shopping in the retail store. The memory 104 includes one or more instructions, and the processor 106 executes the one or more instructions. The processor 106 is configured to detect one or more customers entering the retail store using the input unit 108. In some embodiments, the input unit 108 includes any of a camera, a microphone, or the one or more sensors to detect the one or more customers entering the retail store. The processor 106 is configured to determine whether the one or more customers is a new visitor or an old visitor by detecting a face of the one or more customers. The retail assistance system 102 may include a face recognition system that detects, analyses, and verifies a face of the one or more customers, to determine the one or more customers is the new visitor or the old visitor. In some embodiments, the retail assistance system 102 includes a knowledge database that stores the faces of the new visitor. In some embodiments, the processor 106 is configured to detect the face of the one or more customers by comparing one or more faces of the customer stored in the knowledge database.

The processor 106 is configured to detect an emotional state of the one or more customers by analyzing facial expression of the one or more customers using a machine learning model. The retail assistance system 102 may include an artificial intelligent, AI model to enable the machine learning model. The emotional state of the one or more customers is determined with the facial expression and voice sentiment of the one or more customers. The processor 106 is configured to determine a personality profile of the one or more customers by analyzing the facial expression and one or more personal attributes of the one or more customers using the machine learning model. The one or more personal attributes may include at least one of age, gender, or ethnicity of the one or more customers.

The processor 106 is configured to determine one or more personalized recommendations for the one or more customers by analyzing the personality profile, past purchase history of the one or more customers, and visit history of the one or more customers in the retail store using the machine learning model. The knowledge base may store the one or more personal attributes of the one or more customers if the one or more customers is the new visitor, the past purchase history of the one or more customers, and the visit history of the one or more customers. The processor 106 is configured to enable the one or more customers to choose the one or more personalized recommendations. The retail assistance system 102 may provide the one or more personalized recommendations through an output unit. In some embodiments, the output unit includes any of a display or a speaker.

In some embodiments, the retail assistance system 102 includes one or more assistance systems that provide the one or more recommendations to the one or more customers throughout the retail store. The one or more assistance systems may move through the one or more customers for providing the one or more recommendations. In some embodiments, the processor 104 is configured to determine the one or more personalized recommendations for the one or more customers by tracking in-store purchases of the one or more customers in real-time using the machine learning model, and enable the one or more customers to choose the one or more personalized recommendations.

The retail assistance system 102 may include one or more modules that work together and perform several functions at the retail store to assist the retail store managing the one or more customers, but not limited any of (i) assisting the one or more customers during entry and exit at the retail store, (ii) helping the one or more customers to navigate across the retail store, (iii) customer traffic analysis and prediction in the retail store, (iv) customer preference analysis based on the one or more personal attributes including gender, age, demography, ethnicity, seasons, time and the like, (v) customer purchase monitoring in the retail store, and (vi) monitoring and controlling sales targets of the retail store. The retail assistance system 102 may have a distributed architecture that enables retail outlets located geographically apart to stay connected. The retail assistance system 102 may also direct customers to different parts of the retail store or can connect virtually with different stores located geographically apart to ensure that the customer requirements are met.

The retail assistance system 102 may include a mobile or fixed interactive fixture comprising of sensors, actuators, cameras, audio acquisition systems, and processing units built-in with intelligence that can perform person detection and interacts with the one or more customers with appropriate welcome and goodbye messages. The processor 104 is configured to interact with at least one of a welcome message or a goodbye message by determining whether the one or more customers is entering or exiting the retail store.

The processor 104 may any of interacted with the one or more customers and moved along the customer and helped the customer navigate the store, provide answers to queries from customers, or through open conversation based on the emotional state of the customer, provide product recommendations to the one or more customers based on customer shopping and visiting trends, or provide personalized promotional offers and product recommendations based on but not limited to parameters like customers age, ethnicity, gender, etc.

In some embodiments, the retail assistance system 102 provides promotional offers to people outside the retail store to increase store visits and create potential customers. In some embodiments, the processor 104 tracks the one or more customers through the retail store and calculates the occupancy time of the one or more customers in the retail store. The retail assistance system 102 may also calculate and provide information on which portions of the retail store the one or more customers spent his time. The retail assistance system 102 may include a tracking system that tracks the one or more customers throughout the retail store to provide the one or more recommendations to the one or more customers.

In some embodiments, the processor 104 tracks the one or more customers through the retail store and calculates an occupancy time of the one or more customers in a particular store location, and provides the one or more personalized recommendations based on subsequent visits. The processor 104 may also provide exit messages based on the occupancy time of the one or more customers in the retail store. In some embodiments, the retail assistance system 102 including the processor 104 performs an object detection to identify if items are purchased and then check the electronic tag of items associated with the one or more customers to identify the purchases.

In some embodiments, the processor 104 performs re-identification of the one or more customers if the customer is re-entering the retail store after leaving the retail store for a short while. The retail assistance system 102 may collect all information from movable and fixed fixtures and processes and distributes instructions to ensure that these fixtures do not repeat interactions made by other fixtures which makes the customer experience interesting. The retail assistance system 102 including the processor 104 stores data of people entering the retail store, re-entering the retail store, occupancy time in the retail store, age, emotion of the one or more customers to identify daily, weekly and seasonal patterns, and performs activity detection to detect if the one or more customers located in vicinity to each other are performing social interactions like holding hands, talking to each other and the like.

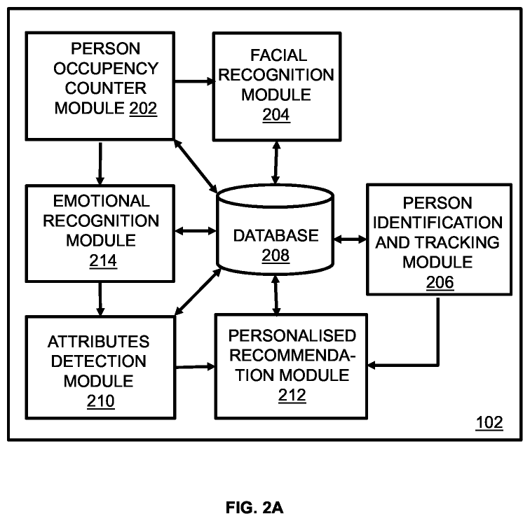

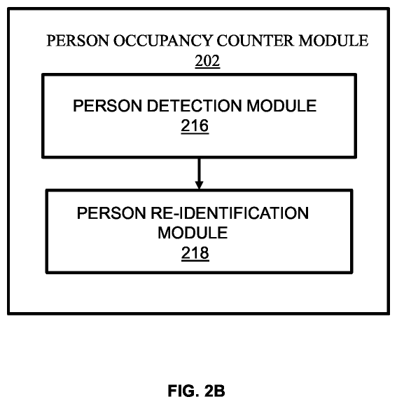

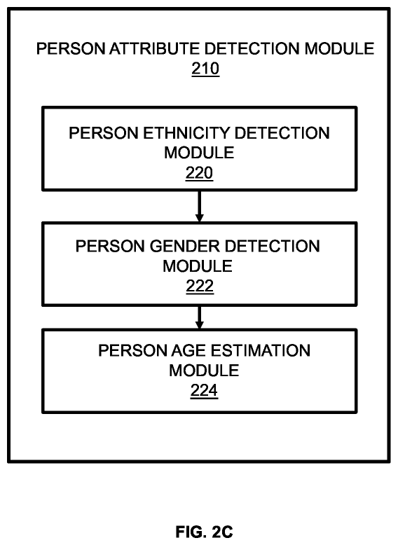

FIG. 2A illustrates a block diagram of the retail assistance system 102 according to some embodiments herein. The retail assistance system 102 includes a person occupancy counter module 202, a facial recognition module 204, an emotional recognition module 214, a person identification and tracking module 206, an attributes detection module 210, a personalized recommendation module 212, and a database 208. In some embodiments, the database 208 is the knowledge database. The person occupancy counter module 202 detects a person or a group entering or exiting a subset of the retail store. The emotional recognition module 214 analyses facial expression to detect emotional states. The person identification and tracking module 206 enables the person or the group is identified as a customer and is tracked in the retail store. The attributes detection module 210 analyses personal attributes like age, gender, age, ethnicity, etc. The personalized recommendation module 212 determines one or more personalized recommendations for the customer. The information regarding the identification of the customer is stored in the database 208 along with the facial recognition data. An appropriate active or passive response may be delivered by an artificially intelligent machine while the person or the group enters or exits the store.

The person occupancy counter module 202 counts the number of people visiting the store and calculates their occupancy based on entry and exit time the store occupancy of customer is calculated. The facial recognition module 204 detects, analyses, and verifies faces of the customers. The sub-modules used to achieve this are, (i) face detection: a machine learning model to detect faces in the frame of the camera, (ii) face recognition: a machine learning model to extract a discrete number of features based on the geometry of the face to remember/memorize the faces the database 208 and later use them to re-verify the same person based on facial features.

The emotional recognition module 214 may include a set of Audio, Image, and NLP machine learning models to identify the emotional state of the customer which can take any of these seven forms like disgusted, sad, happy, excited, surprised, neutral, or angry. The expressions associated with the customer are based on facial expression, voice sentiment, and textual conversation sentiment analysis.

The personalized recommendation module 212 includes an artificially intelligent (AI) recommendation algorithm which tracks in-store purchases for customers and recommends similar items within the same retail store and may also recommend other stores such as similar clothing items or brands, similar toys in Hamleys, similar gaming titles/consoles, similar food items based on the customer preferences segregated by age/ethnicity/gender combined with the customer's buying capacity as detected by a previous history of purchases made at the retail store, stored at the database 208, and their emotional state as detected by the processing the input from the one or more sensors 106A-N. There may be one or more AI machine assistants for attaining to the customer. In some embodiments, the AI machine assistants are the one or more assistance systems of the retail assistance system 102. Each AI machine assistant has a microphone, a camera, and the AI model 104 in communication with the retail assistance system 102. The AI machine assistants may be 4-5 feet height with a screen and a fixed or moving platform. These AI machine assistants have conversation capabilities using a microphone and multiple speakers with powerful computing AL model to perform the following tasks, (i) make word detection to initiate a conversation with the customers, (ii) Speech understanding module for converting speech to text, (iii) artificially intelligent NLP module performing intent and entity detection to understand the speech and generate an appropriate response, (iv) running a text-to-speech module to give the generated response back to the user, (v) beamforming to orient the head towards the user having an active conversation, (vi) display emotive expression on its display, etc. The AI machine assistants may be connected wirelessly to the retail assistance system 102 which can be called the brain of the whole monitoring system. The retail assistance system 102 has the knowledge and history of all the persons who visited the store in the past along with their attributes with the help of installed cameras and microphone arrays installed on the robot devices.

The AI machine assistants may greet the customer on a person-to-person basis remembering not just their name and faces, but also their preferences. These assistants also help customers navigate inside big stores to find the right commodity/article quickly. Various questions may be asked to the AI machine assistants. For example, a question may be “Where do I find <commodity/article> from <brand/description>”, Context or Intent is identified as article, location, and entity as article <name> example, where can I find jackets from Tommy Hilfiger. The AI machine assistant gives the directions for the respective section or inventory rack in the retail store or suggests another store nearby. In another instance, a question may be, can you help me with the directions for <store>. In case of a shopping mall, Intent: store, location, Entity: store name, the AI machine assistant gives the directions for the respective store. In another instance, a question may be “Can you recommend a similar store for <store>”, for example, can you recommend similar sports outlets like Adidas, The AI machine assistant gives information of Nike, Under Armour, Puma, and the like.

The machine learning model may compute customer's preferences using a type of commodities/articles purchased, a particular brand accessory, a clothing item or a food item, purchase time and date, with a pattern of visit such as regular Saturdays/Sundays, the price range of commodities such as 0-5k, 5k-10k, >20k, sub-section occupancy and visit history within the retail store such as footwear visited most often as compared to other sub-sections. The customer preferences are combined with the customer attributes such as age, gender, ethnicity or ethnic group, an average emotional state during store and its section visit to generate an appropriate active or passive response at the AI machine assistant, automating the process of customizing promotions, managing customer satisfaction and efficiency of the retail store. The retail assistance system 102 may continuously generate a personalized recommendation matrix by analyzing the customer attributes and preferences, which keeps on recommending items to the one or more customers with the help of the AI machine assistants.

FIG. 2B illustrates a block diagram of the person occupancy counter module 202 according to some embodiments herein. The person occupancy counter module 202 includes a person detection module 216 and a person re-identification module 218. The person occupancy counter module 202 counts the number of people visiting the retail store and calculates their occupancy based on an entry time and an exit time of the retail store. The person detection module 216 is configured to detect and track people in the frame of the camera using the machine learning model. The person detection module 216 may independent of gender, age, height, or ethnicity of the one or more customers. The person re-identification module 218 is configured to re-identify the one or more customers using the machine learning model if the one or more customers goes out of a frame of the input unit 108 and then re-enters. The person detection module 216 recognizes and remembers the one or more customers based on his/her dressing style as well as body attributes on a same day or even within a lifespan of customer visits to the retail store.

FIG. 2C illustrates a block diagram of the person attribute detection module 210 according to some embodiments herein. The person attribute detection module 210 includes a person ethnicity detection module 220, a person gender detection module 222, and a person's age estimation module 224. The person ethnicity detection module 220 includes a set of AI natural language processing model, image processing, and audio processing models to detect a person's ethnicity based on their registered name at the time of the entry into the retail store or the shopping mall, their facial and body features as well as voice accent. The person gender detection module 222 includes a set of AI models, for example, Image processing and audio, to detect the gender of a person using facial and body features as well as the pitch of the voice. The person age estimation module 224 carries out an age estimation taking into consideration one or more attributes such as facial features, walking speed (elderly) and body features including height of the one or more customers to differentiate between kids and adults.

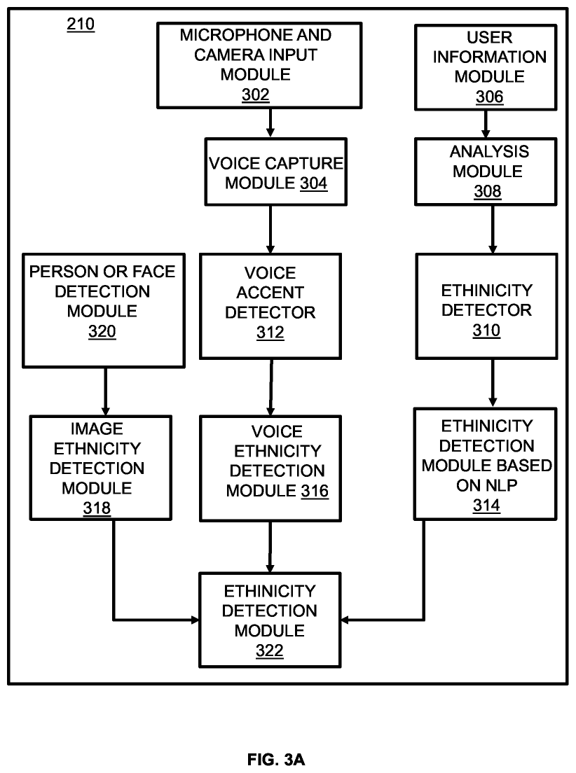

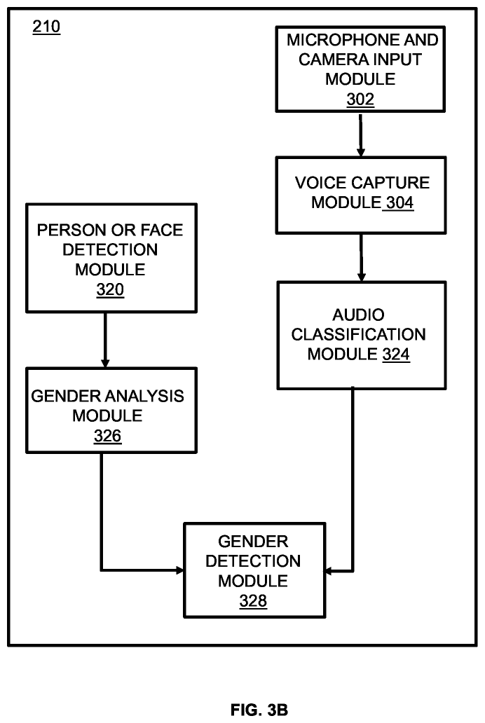

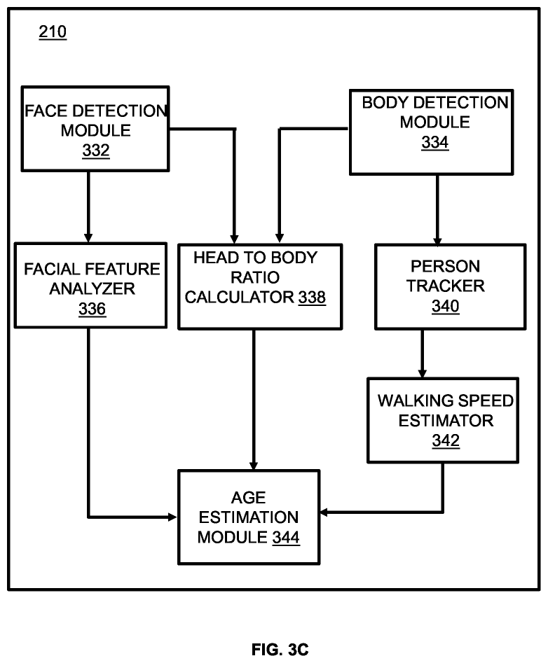

FIG. 3A illustrates an exemplary block diagram of the person attribute detection module 210 for detecting ethnicity according to some embodiments herein. The person attribute detection module 210 includes a microphone and camera input module 302, a voice capture module 304, a user information module 306, an analysis module 308, an ethnicity detector 310, a voice accent detector 312, an ethnicity detector module based on natural language processing (NLP) module 314, a voice ethnicity detection module 316, image ethnicity detection module 318, a person or face detection module 320 and an ethnicity detection module 320. The input from the sub-section includes the one or more customers visits or interacts with the AI machine assistant enables to process the microphone and the camera at the microphone and camera input module 302. The voice associated with the one or more customers is captured at the voice capture module 304. The user information module 306 retrieves information of the one or more customers from a store register. In some embodiments, the store register is the knowledge database. The information may be user information including a name and address of the one or more customers. The analysis module 308 analyses the user information such as name or family name to find an ethnic context, for example, area, name, or family name may provide one or more contents for ethnicity. The ethnicity detector 310 determines ethnicity based on the personal information alone. The ethnicity detection module is based on natural language processing, NLP module 314 analyses speech to determine ethnicity of the one or more customers. The voice ethnicity detection module 316 uses accents analysis to determine ethnicity. The image ethnicity detection module 318 uses visual data for ethnic context, for example, clothing, braids, symbols belonging to ethnic group, etc. The person or face detection module 320 identifies the one or more customers from the knowledge database by recording and analyzing facial features of the one or more customers for ethnicity detection. The ethnicity detection module 320 combines the analysis based on the personal information, image, voice, and NLP analysis and generates an output of a possible ethnicity of the one or more customers. The ethnicity may be customised for the AI machine assistant to interact with the one or more customers at the retail store to guide and assist the one or more customers with customized assistance. The ethnicity may include a particular group of people having similar interests, region, or belief systems.

FIG. 3B illustrates an exemplary block diagram of the person attribute detection module 210 for detecting a gender according to some embodiments herein. The person attribute detection module 210 includes the microphone and camera input module 302, the voice capture module 304, an audio classification module 324, a gender analysis module 326, the person or face detection module 320, and a gender detection module 328. Facial features or a body of the one or more customers is captured and analyzed at the person or face detection module 320. The microphone and camera input module 302 processes the microphone or camera input at the AI machine assistant and the machine learning model, The voice capture module 304 captures and identifies a voice associated with the one or more customers and converts the voice to text for processing. The audio classification module 324 determine audio properties of the voice and enable the gender detection module 328 to detect the gender of the one or more customers. The gender analysis module 326 determines the gender based on the facial features of the one or more customers. For example, jaw-line, eye brows, hairline, facial proportion, head circumference to the body ratio, and the like may enable the gender analysis module 326 to determine the gender. Body of the one or more customers may be analyzed to match features of genders, for example, hip ratio, shoulder to hip ratio, etc, and the input is provided to the gender detection module 330 to determine the gender of the one or more customers. The AI machine assistant may provide specialized recommendations based on the determined gender along with ethnicity, age, preferences, and personal shopping or browsing history of the customer.

FIG. 3C illustrates an exemplary block diagram of the person attribute detection module 210 for detecting age according to some embodiments herein. The person attribute detection module 210 may include a face detection module 332, a body detection module 334, a facial feature analyzer 336, a head to body ratio calculator 338, a person tracker 340, a walking speed estimator 342, and an age estimation module 344. The face detection module 332 detects a face and facial features of the one or more customers. The facial feature analyzer 336 analyses the facial features for proportion, a ratio of the face to the head taking into account the gender, presence or absence of aging signs like height, wrinkles, hairline, etc. The age estimation module 344 determines an age of the one or more customers. The body detection module 334 captures the body of the one or more customers and analyses for posture. The person tracker 340 captures the sub-sections visited at the retail store and the walking speed estimator 342 determines an approximate walking speed of the one or more customers to give input to the age estimation module 344 to estimate the age of the one or more customers. The AI machine assistant may generate appropriate responses and assist the one or more customers based on the estimated age.

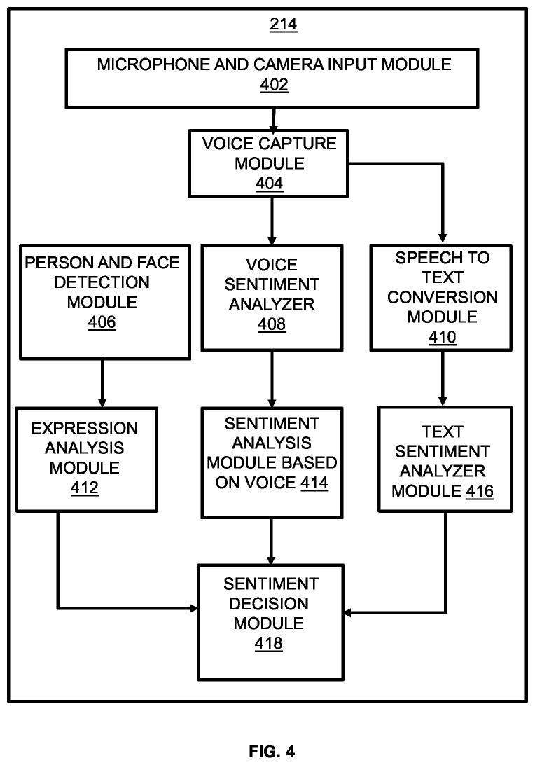

FIG. 4 illustrates a block diagram of the emotional recognition module 214 according to some embodiments herein. The emotional recognition module 214 includes a microphone and camera input module 402, a voice capture module 404, a person and face detection module 406, a voice sentiment analyzer 408, a speech to text conversion module 410, an expression analysis module 412, a sentiment analysis module based on voice 414, a text sentiment analyzer module 416, and a sentiment decision module 218. The microphone and camera input module 402 captures and processes visual data and voice associated with the one or more customers. The voice capture module 404 captures the voice of the one or more customers and convert it to text for processing. The person and face detection module 406 identifies the person as a customer from the previous data captured at the database. The voice sentiment analyzer 408 analyses voice to determine an emotion. For example, the emotion may be happiness, sadness, anger, excitement, and the like. The speech to text conversion module 410 converts spoken words by the one or more customers to text. The expression analysis module 412 analyses facial expression to determine a present emotional state of the one or more customers. The sentiment analysis module based on voice 414 determines a present emotional state of the one or more customers based on voice analysis. The text sentiment analyzer module 416 analyses the converted text to analyze the emotions in the words used. The sentiment decision module 418 receives input from all the modules to determine sentiments of the one or more customers.

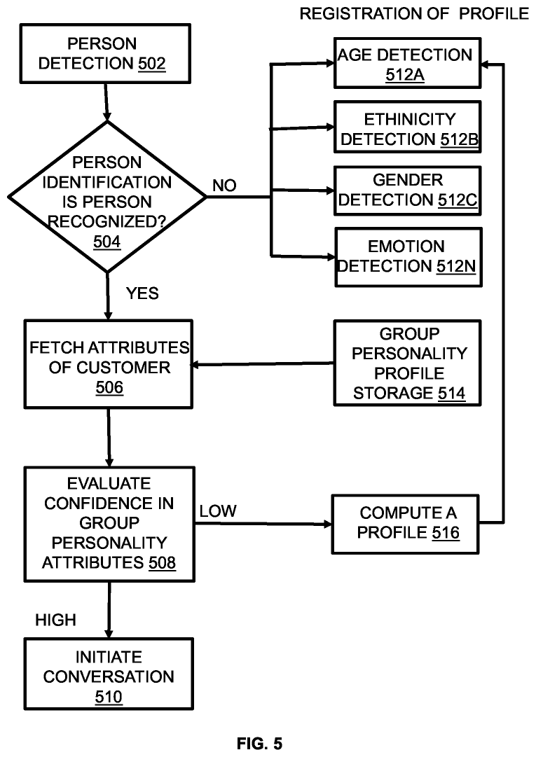

FIG. 5 illustrates a flow diagram of the retail assistance system 102 to initiate a conversation according to some embodiments herein. At a step 502, a person is detected and analysed for identification from the database of the retail assistance system 102, and identifies that the person is recognized at a step 504. If the person is identified as already captured customer, captured attributes of the customer are fetched at a step 506. If the customer is visiting in a group of two or more, confidence in the group personality attributes is determined at a step 508, and if high confidence score is generated, the AI machine initiates a conversation with the customer or the group at a step 510. If a person is detected that is not identified at the step 504, a registration of profile of new customer is created at steps 512A-N that includes detecting of age, ethnicity, gender, emotions and stored in the knowledge database. If the confidence score that is generated for the customer is low, the AI machine may compute a profile of the customer at a step 516.

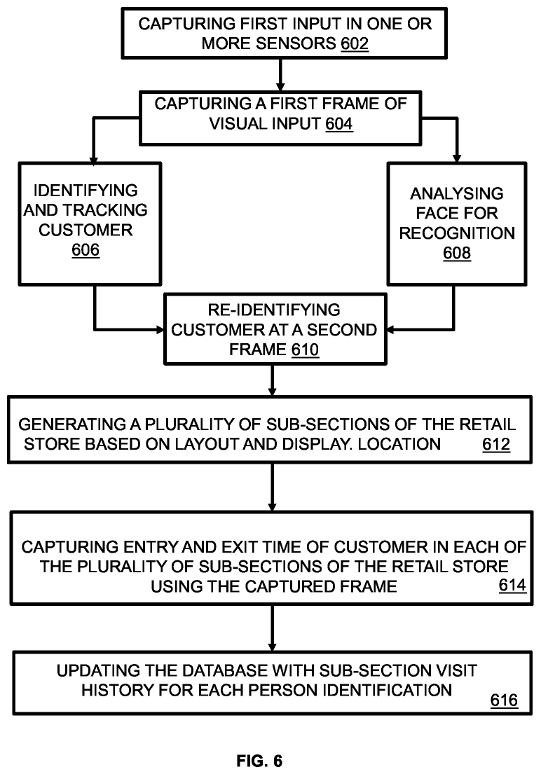

FIG. 6 illustrates a flow diagram of a method of capturing retail store visit data according to some embodiments herein. At a step 602, a first input is captured in the one or more sensors. At a step 604, a first frame of visual input is captured. At a step 606, customers are identified and tracked, and at a step 608, one or more faces are analysed for face recognition. At a step 610, the one or more customers are re-identified when they appear in second input captured at the one or more sensors in the second frame of visual input. At a step 612, one or more sub-sections of the retail store are generated based on a layout and a display location. At a step 614, an entry and an exit time of the customer are captured in each of the one or more sub-sections of the retail store using the captured one or more first frames and one or more second frames. At a step 616, the database is updated with a sub-section visit history for each person's identification.

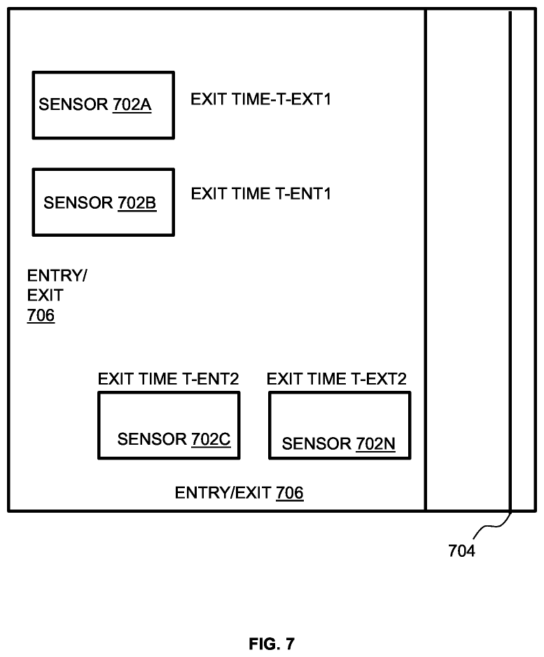

FIG. 7 illustrates an exemplary graphical representation of placements of one or more sensors at the retail store according to some embodiments herein. The graphical representation includes one or more sensors 702A-N, and a shelf 704 to store products. The one or more sensors 702A-N includes a first sensor 702A and a second sensor 702B that are placed in a first position near an entry or exit 706, and a third sensor 702C and a fourth sensor 702N placed near an entry or exit 706. The shelf 704 may include one or more shelves. The products on each shelf of each sub-section are identified and known. The one or more customers may be captured using the one or more sensors 702A-N while entering, exiting, or interacting with the products on the shelf 704 or interacting among each other, and data is stored at the knowledge database to feed the machine learning model.

In some embodiments, the retail assistance system 102 functions as a mobile or fixed interactive fixture comprising sensors, actuators, cameras, audio acquisition systems and processing units built in with intelligence to perform group identification of the customer entering the store based on social activity detection. In some embodiments, the retail assistance system 102 performs group identification of new people entering the store in a group to the already saved group database based on social activity detection.

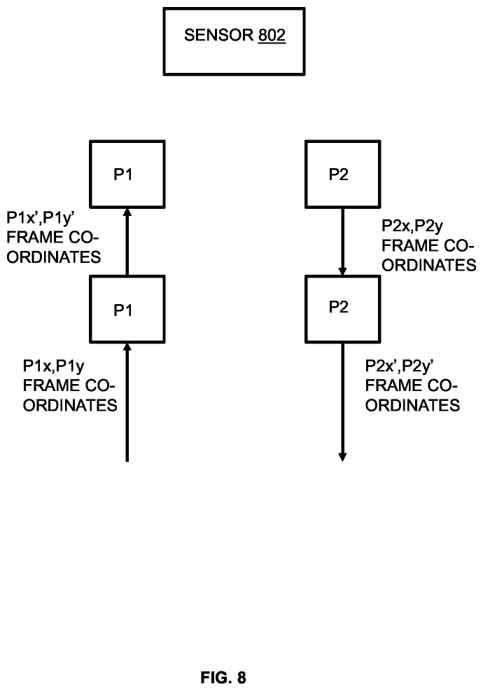

FIG. 8 illustrates an exemplary graphical representation of tracking of the one or more customers at the retail store according to some embodiments herein. The graphical representation includes a sensor 802, and one or more customers P1 and P2. In some embodiments, the sensor 802 is the input unit. The sensor 802 captures first input of visual data and a second input of visual data and may identify a person as the customer P1. The customer P1 and P2 are the persons captured within a frame with co-ordinates X-axis and Y-axis of the visual data at the first input and the second input respectively. P1x, P1y may be the first input co-ordinates, and P2x, P2y may be the second input coordinates. If the first input P2y−the second input P2y is a negative value, it means the customer P2 is determined to be moving away from the sensor 802. If the first input Ply−the second input Ply is a positive value, the customer P1 is determined to be moving in a direction of the sensor 802. The tracking data is analysed further to determine occupancy of the customer in each of the sub-sections of the store, and also to determine speed of walking, sub-sections visited, products interest, etc.

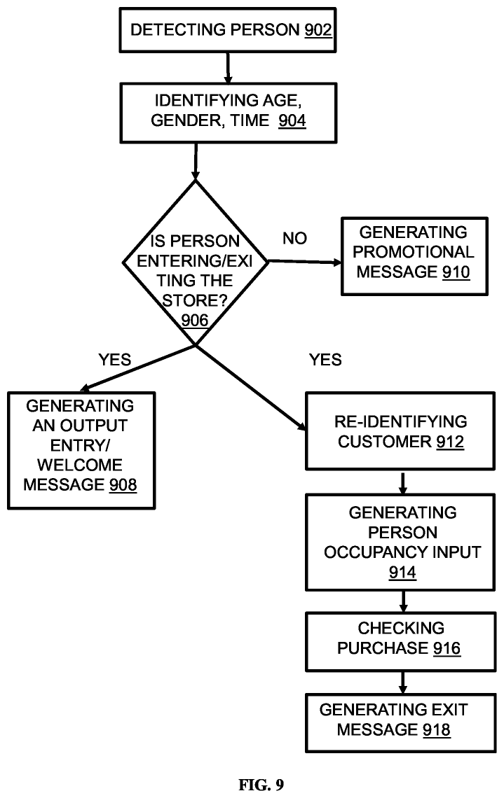

FIG. 9 illustrates an exemplary flow chart of generating an output at the AI machine assistant according to some embodiments herein. At a step 902, a person is detected and age, gender and time of visit of the person are identified using the machine learning model at a step 904. At a step 906, person entering/exiting the retail store is determined. If the person is entering the retail store is determined, an output of entry/welcome message is generated at a step 908. If the person is not entering the retail store, a promotional message may be generated at a step 910. The promotional message may be targeting the age, gender, or time of the visit. When the person is exiting the retail store, the person is re-identified as the customer with identification number at a step 912, an occupancy input is generated having information of a distribution of time spent in sub-sections of the retail store at a step 914. If the customer made a purchase, the purchase is checked and recorded in the knowledge database at a step 916. At a step 918, an customized exit message is generated for the customer based on their preferences, ethnicity, time of the visit, age, gender, etc.

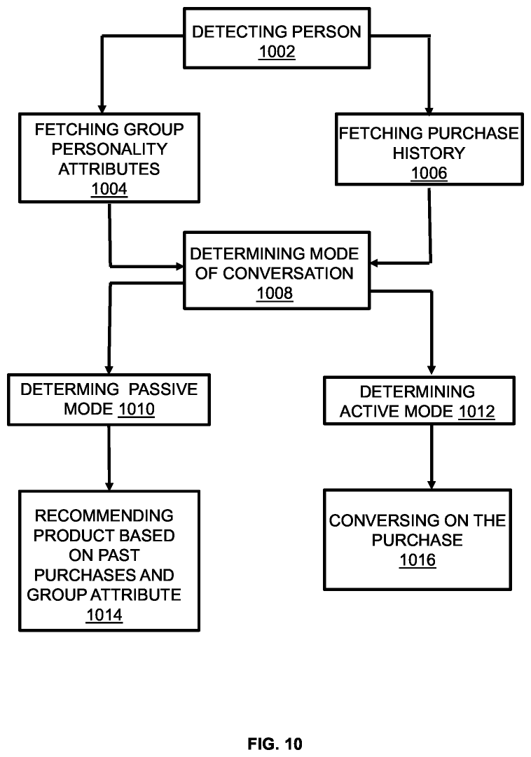

FIG. 10 illustrates an exemplary flow chart of a method of generating an output on the retail assistance system 102 based on modes of conversation of at least one of the customer according to some embodiments herein. At a step 1002, a person or a group is detected and identified from the database. At a step 1004, the group personality attributes are fetched from the database. At a step 1008, a mode of conversation is determined based on the knowledge available in the database. At a step 1010, a passive mode is determined while at step 1012, active mode is determined. At a step 1014, if passive mode is determined, the AI machine assistant recommends products based on past purchases and group attributes as determined. At a step 1016, an active mode is determined, and the AI machine assistant converses on the purchase made by the customer. In the active mode, the AI machine assistant initiates the conversation without any prior knowledge. In passive mode, the AI machine assistant converses with the customer based on prior knowledge and factors like age, ethnicity, culture, previous visits, etc.

In some embodiments, the AI machine assistant recommends additional products if the one or more customers has purchased a product by generating an interpersonal conversation. If the one or more customers has not made any purchase, the AI machine assistant, generates the interpersonal conversation with the one or more customers based on prior knowledge and factors like age, ethnicity, culture, previous visits in the passive mode, and past purchases in the active mode of conversation.

In some embodiments, the retail assistance system 102 performs analysis of items purchased by the customer and provides ad-on suggestions to the customer. In some embodiments, the retail assistance system 102 interacts with the one or more customers and collect attributes related to the customer like age, ethnicity, culture, gender, etc. In some embodiments, the retail assistance system 102 enables warehousing robots to ship the items purchased by the customer vehicles or transport the purchase made to the customer specified destination. In some embodiments, the retail assistance system 102 is provided control over the prices of each item in the retail store. The retail assistance system 102 may also control add-on ad promotional products.

In some embodiments, the retail assistance system 102 enables the fixtures or AI machine assistants at various locations across the retail store to be location aware. The AI machine assistant knows its location within the retail store and are aware of the items placed in its vicinity, which initiates conversation of promotion and sales within the vicinity of the AI machine assistant. If the customer is not interested in items near the vicinity of the AI machine assistant, the AI machine assistant recommends or redirects the customers, based on the input received by generating interaction with the customer. In some embodiments, the AI machine assistant includes a locomotive system like a cart to carry items the customers are interested to purchase.

In some embodiments, the AI machine assistants are given sales targets to achieve and the retail assistance system 102 controls cost of items based on the target. The retail assistance system 102 may integrate with online marketing tools and uses online audiovisual placeholders on advertisement banners as an extension of audio visual display of the retail store and provides promotion advertisements and offers based on online personality analysis profile of people entering online stores on social media. In some embodiments, the AI machine assistant is capable of collecting payment. The machine learning model communicates with the internet via the retail assistance system 102 and enables payment processing modality for the customer. The retail assistance system 102 may offer credit-based facilities to the customer to maximize the sales goals for daily, quarterly and annual targets based on parameters like but not limited to customer credit history, personality profile, purchase history at the retail store etc. In some embodiments, the retail assistance system 102 determines the spaces of maximum occupancy in the store based on analysis at a given time. Occupancy means a number of customers at a particular sub-section or whole of the retail store. The sub-sections may be used to place products related to collective group characteristics of customers using that sub-section. In some embodiments, the AI machine assistant performs emotion analysis based on micro-expressions of the customer and generates a response accordingly during an interaction during the active mode or passive mode of the conversation.

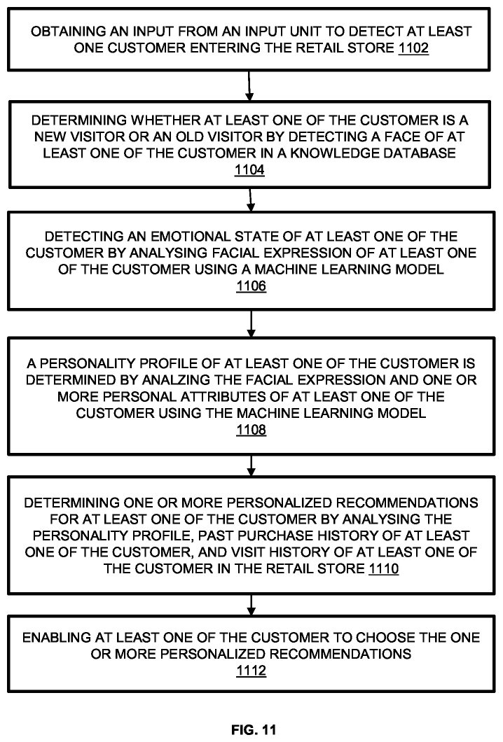

FIG. 11 is a flow diagram of a method of assisting customers while shopping in the retail store according to some embodiments herein. At a step 1102, an input is obtained from the input unit to detect at least one customer entering the retail store. At a step 1104, whether the one or more customers is a new visitor or an old visitor is determined by detecting a face of the one or more customers in a knowledge database. At a step 1106, an emotional state of the one or more customers is detected by analyzing facial expression of the one or more customers using a machine learning model. At a step 1108, a personality profile of the one or more customers is determined by analyzing the facial expression and one or more personal attributes of the one or more customers using the machine learning model. The one or more personal attributes includes at least one of age, gender, or ethnicity of the one or more customers. At a step 1110, one or more personalized recommendations is determined for the one or more customers by analyzing the personality profile, past purchase history of the one or more customers, and visit history of the one or more customers in the retail store. At a step 1112, the one or more customers is enabled to choose the one or more personalized recommendations.

In some embodiments, the retail assistance system 102 generates a response or recommendations at the AI machine assistant based on the attributes, emotions, time, purchase, etc. In some embodiments, the retail assistance system 102 interacts with the one or more customers to provide the one or more personalized recommendations.

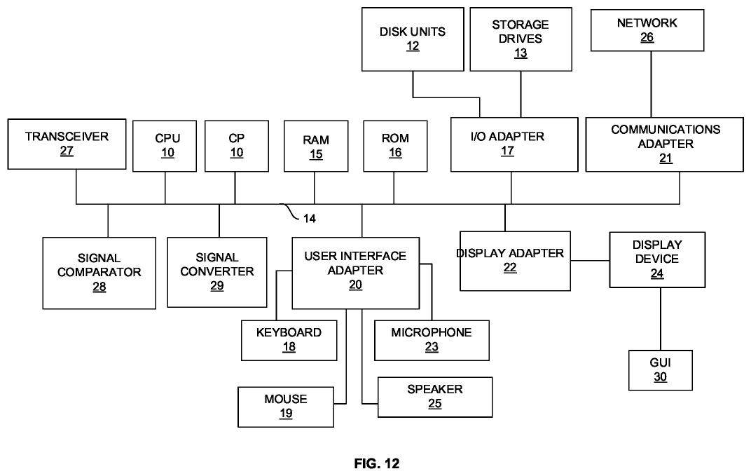

A representative hardware environment for practicing the embodiments herein is depicted in FIG. 12, with reference to FIGS. 1 through 11. This schematic drawing illustrates a hardware configuration of an expression analyzer 110/computer system/computing device in accordance with the embodiments herein. The system includes at least one processing device CPU 10 that may be interconnected via system bus 15 to various devices such as a random-access memory (RAM) 12, read-only memory (ROM) 16, and an input/output (I/O) adapter 18. The I/O adapter 18 can connect to peripheral devices, such as disk units 58 and program storage devices 50 that are readable by the system. The system can read the inventive instructions on the program storage devices 50 and follow these instructions to execute the methodology of the embodiments herein. The system further includes a user interface adapter 22 that connects a keyboard 28, mouse 50, speaker 52, microphone 55, and/or other user interface devices such as a touch screen device (not shown) to the bus 15 to gather user input. Additionally, a communication adapter 20 connects the bus 15 to a data processing network 52, and a display adapter 25 connects the bus 15 to a display device 26, which provides a graphical user interface (GUI) 56 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the invention.

I/We claim:

1. A retail assistance system (102) for assisting customers while shopping in a retail store, wherein the retail assistance system (102) comprises,
a memory (104) that comprises one or more instructions; and
a processor (106) that executes the one or more instructions, wherein the processor (106) is configured to:
detect, using an input unit (108), at least one customer entering the retail store;
determine whether at least one customer is a new visitor or an old visitor by detecting a face of at least one customer;
detect, using a machine learning model, an emotional state of at least one customer by analyzing facial expression of at least one customer;
characterized in that,
determine, using the machine learning model, a personality profile of at least one customer by analyzing the facial expression and one or more personal attributes of at least one customer, wherein the one or more personal attributes comprises at least one of age, gender, or ethnicity of at least one customer;
determine, using the machine learning model, one or more personalized recommendations for at least one customer by analyzing the personality profile, past purchase history of at least one customer, and visit history of at least one customer in the retail store; and
enable the at least one of customer to choose the one or more personalized recommendations.

2. The retail assistance system (102) as claimed in claim 1, wherein the processor (106) is configured to:
determine, using the machine learning model, the one or more personalized recommendations for at least one customer by tracking in-store purchases of at least one customer in real-time; and
enable at least one customer to choose the one or more personalized recommendations.

3. The retail assistance system (102) as claimed in claim 1, wherein the retail assistance system (102) comprises a knowledge database that stores the one or more personal attributes of at least one customer if at least one customer is the new visitor, the past purchase history of at least one customer, and the visit history of at least one customer.

4. The retail assistance system (102) as claimed in claim 1, wherein the input unit (108) comprises any of a camera, a microphone, or a plurality of sensors to detect at least one customer entering the retail store.

5. The retail assistance system (102) as claimed in claim 1, wherein the retail assistance system (102) comprises a face recognition system that detects, analyzes, and verifies a face of at least one customer, to determine at least one customer is the new visitor or the old visitor, wherein the faces of new visitor are stored in the knowledge database, wherein the processor (106) is configured to detect the face of the at least one customer by comparing one or more faces of the customer stored in the knowledge database.

6. The retail assistance system (102) as claimed in claim 1, wherein the retail assistance system (102) comprises a tracking system that track at least one customer throughout the retail store to provide the one or more recommendations to at least one customer.

7. The retail assistance system (102) as claimed in claim 4, wherein the plurality of sensors comprises any of an array of cameras or audio acquisition systems.

8. The retail assistance system (102) as claimed in claim 1, wherein the processor (106) is configured to interact at least one of a welcome message or a goodbye message by determining whether at least one customer is entering or exiting the retail store.

9. A method of assisting customers while shopping in a retail store, wherein the method comprises,
detecting, using an input unit (108), at least one customer entering the retail store;
determining whether at least one customer is a new visitor or an old visitor by detecting a face of at least one customer in a knowledge database;
detecting, using a machine learning model, an emotional state of at least one customer by analyzing facial expression of at least one customer;
determining, using the machine learning model, a personality profile of at least one customer by analyzing the facial expression and one or more personal attributes of at least one customer, wherein the one or more personal attributes comprises at least one of age, gender, or ethnicity of at least one customer;
determining, using the machine learning model, one or more personalized recommendations for at least one customer by analyzing the personality profile, past purchase history of at least one customer, and visit history of at least one customer in the retail store; and
enabling the at least one of customer to choose the one or more personalized recommendations.

10. The method as claimed in claim 9, wherein the method comprises,
determining, using the machine learning model, the one or more personalized recommendations for at least one customer by tracking in-store purchases of at least one customer in real-time; and
enabling at least one customer to choose the one or more personalized recommendations.
